(19) United States
(12) Patent Application Publication
(10) Pub. No.: US 2009/0136214 A1
(43) Pub. Date: May 28, 2009

(54) Recording apparatus and method, and program

(75) Inventor: Toshihiro Ikegami, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/070,635

(22) Filed: Feb. 20, 2008

(30) Foreign Application Priority Data
Feb. 22, 2007 (JP) P2007-042545

(51) Int. Cl. H04N 7/26; G06T 7/00

(52) U.S. Cl. 386/124; 386/E05.007; 382/181

(57) ABSTRACT

A recording apparatus for recording one or more pieces of content provided as stream data on a recording medium includes a bit-rate setting unit configured to variably set a bit rate when a processing unit part is recorded on the recording medium in accordance with content in the processing unit part within the one or more pieces of content for each processing unit part for which a recording process is performed on the recording medium within the stream data; and a recording controller configured to perform control so that the stream data is sequentially recorded on the recording medium for each processing unit part at each bit rate that is variably set for each processing unit part by the bit-rate setting unit.

### CROSS-REFERENCE TO RELATED APPLICATIONS

The present application claims priority from Japanese Patent Application No. JP 2007-042545 filed in the Japanese Patent Office on Feb. 22, 2007, the entire content of which is incorporated herein by reference.

### BACKGROUND OF THE INVENTION

1. Field of the Invention

The present invention relates to a recording apparatus and method, and a program. More particularly, the present invention relates to a recording apparatus and method with which effective utilization of a limited recording capacity is made possible so that not only the main part of a broadcast program, but also parts other than the main part are recorded and to a program for use therewith.

2. Description of the Related Art

In recent years, recording apparatuses capable of recording broadcast programs, for example, hard disks and optical disc video recorders, have become very popular. Furthermore, for the recording media therefor, for example, hard disks, optical discs such as Blu-ray (trademark) discs and DVDs (Digital Versatile Disks) have been used, and the increase in their recording capacity has been marked.

Therefore, such recording apparatuses in which the recording capacity has increased are correspondingly capable of having a large number of broadcast programs recorded thereon. Therefore, users have started to use such recording apparatuses in such a manner that as large a number as possible of broadcast programs are recorded for the time being, and after recording, only the desired broadcast programs are viewed.

However, even though the recording capacity of recording media has increased markedly, the recording capacity of recording media, such as hard disks and optical discs, is not limitless, but limited. Therefore, in order to maximize the number of broadcast programs that can be recorded, there has been a demand for realizing a technology capable of effectively utilizing the limited recording capacity of recording media. For this reason, in the related art, a technology for recording only main parts of broadcast programs and the like on a recording medium, that is, a technology for cutting portions other than the main parts, for example, CMs (Commercial Messages) that are broadcast in the intervals between broadcast programs has been widely used (see, for example, Japanese Unexamined Patent Application Publication Nos. 3-158086 and 3-262287).

### SUMMARY OF THE INVENTION

However, if such a technology of the related art for cutting parts other than the main parts, such as CMs, is used as is, various problems will arise.

For example, as items to be viewed by the user after recording, there are cases in which not only the main part of a broadcast program, but also parts other than the main part, such as CMs, are made to be items to be viewed. However, in such a case, a problem arises in that it is difficult for the user to view items desired to be viewed, that is, parts other than the main parts, such as CMs.

For example, when the detection of parts other than the main parts, such as CMs, fails, there is a possibility that the recording of the main parts fails. As a result, simply adopting the technology of the related art has a risk.

The present invention has been made in view of such circumstances. It is desirable to aim to effectively utilize the limited recording capacity of a recording medium while targeting not only the main parts of broadcast programs, but also parts other than the main part as items to be recorded.

According to an embodiment of the present invention, there is provided a recording apparatus for recording one or more pieces of content provided as stream data on a recording medium, the recording apparatus including: bit-rate setting means for variably setting a bit rate when a processing unit part is recorded on the recording medium in accordance with content in the processing unit part within the one or more pieces of content for each processing unit part for which a recording process is performed on the recording medium within the stream data; and recording control means for performing control so that the stream data is sequentially recorded on the recording medium for each processing unit part at each bit rate that is variably set for each processing unit part by the bit-rate setting means.

The recording apparatus may further include feature information detection means for detecting feature information indicating a predetermined feature of the processing unit part; and content recognition means for recognizing the content in the processing unit part on the basis of the feature information detected by the feature information detection means, wherein the bit-rate setting means variably sets a bit rate for the processing unit part in accordance with the recognized content of the content recognition means.

The one or more pieces of content constituting the stream data may be classified into a first type or a second type whose degree of importance is defined in advance to be lower than that of the first type, and when the processing unit part corresponds to the first type of content, the bit-rate setting means sets the first bit rate as a bit rate for the processing unit part, and when the processing unit part corresponds to the second type of content, the bit-rate setting means sets the second bit rate lower than the first bit rate as a bit rate for the processing unit part.

The first type may be a main part section of the content and the second type of content is a commercial message section thereof.

The first type may be a highlight scene of the content, and the second type may be a general scene.

The bit-rate setting means may perform setting of varying a screen resolution for the processing unit part as a variable setting of a bit rate for the processing unit part.

The stream data may be compression-coded in accordance with a predetermined type of compression format and is recorded on the recording medium, and the bit-rate setting means may perform setting of varying the predetermined types of compression formats applied to the processing unit part as a variably setting of a bit rate for the processing unit part.

The recording method and the program according to embodiments of the present invention are a recording method and a program for use with the recording apparatus according to the embodiment of the present invention, respectively.

In the recording apparatus and method, and the program according to embodiments of the present invention, one or more pieces of content provided as stream data are recorded on a recording medium in the following manner. That is, a bit rate when a processing unit part is recorded on the recording medium in accordance with content in the processing unit part among the one or more pieces of content is variably set for each processing unit part for which a recording process is performed on the recording medium within the stream data, and the stream data is sequentially recorded on the recording medium for each processing unit part at each bit rate that is variably set for each processing unit part by the bit-rate setting means.

As has been described above, according to embodiments of the present invention, it is possible to record stream data on a recording medium. In particular, when stream data is composed of content of different types, such as main parts of broadcast programs or parts other than the main parts thereof, it is possible to effectively utilize the limited recording capacity of a recording medium while recording stream data including parts other than the main parts.

### BRIEF DESCRIPTION OF THE DRAWINGS

FIG. 1 is a functional block diagram showing an example of the functional configuration of a recording apparatus according to an embodiment of the present invention;

FIG. 2 is a flowchart illustrating an example of a content recording process of the recording apparatus shown in FIG. 1;

FIG. 3 is a block diagram showing an example of the hardware configuration of the recording apparatus shown in FIG. 1 when the recording apparatus is configured to support an analog broadcast;

FIG. 4 is a block diagram showing an example of the hardware configuration of the recording apparatus shown in FIG. 1 when the recording apparatus is configured to support a digital broadcast;

FIG. 5 is a block diagram showing another example of the hardware configuration of the recording apparatus shown in FIG. 1 when the recording apparatus is configured to support an analog broadcast; and

FIG. 6 is a block diagram showing still another example of the hardware configuration of the recording apparatus of FIG. 1 when the recording apparatus is configured to support an analog broadcast.

### DESCRIPTION OF THE PREFERRED EMBODIMENTS

Before describing an embodiment of the present invention, the correspondence between the features of the claims and the specific elements disclosed in an embodiment of the present invention is discussed below. This description is intended to assure that an embodiment supporting the claimed invention is described in this specification. Thus, even if an element in the following embodiment is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

Furthermore, this description should not be construed as restricting that all the embodiments of the invention disclosed in the embodiment are described in the claims. That is, the description does not deny the existence of embodiments of the present invention that are described in the embodiment but not claimed in the invention of this application, i.e., the existence of embodiments of the present invention that in future may be claimed by a divisional application, or that may be additionally claimed through amendments.

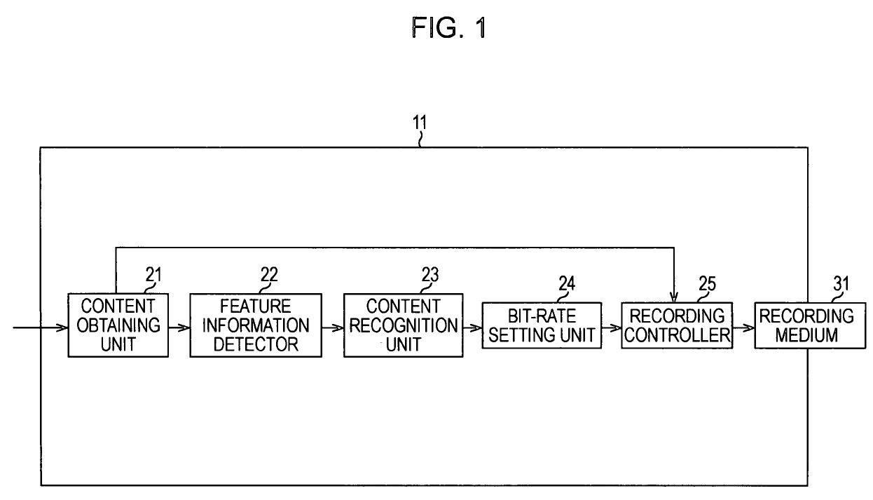

A recording apparatus (for example, a recording apparatus 11 in FIG. 1) includes bit-rate setting means (for example, a bit-rate setting unit 24 in FIG. 1) for variably setting a bit rate when a processing unit part is recorded on the recording medium in accordance with content in the processing unit part within the one or more pieces of content for each processing unit part for which a recording process is performed on the recording medium within the stream data; and recording control means (for example, a recording controller 25 in FIG. 1) for performing control so that the stream data is sequentially recorded on the recording medium for each processing unit part at each bit rate that is variably set for each processing unit part by the bit-rate setting means.

The recording apparatus further includes feature information detection means (for example, a feature information detector 22 in FIG. 1) for detecting feature information indicating a predetermined feature of the processing unit parts; and content recognition means (for example, a content recognition unit 23 in FIG. 1) for recognizing the content in the processing unit part on the basis of the feature information detected by the feature information detection means, wherein the bit-rate setting means variably sets a bit rate for the processing unit part in accordance with the recognized content of the content recognition means.

The one or more pieces of content constituting the stream data is classified into a first type (for example, a “main part section” (to be described later)) or a second type (for example, a “CM section” (to be described later)) whose degree of importance is defined in advance to be lower than that of the first type, and when the processing unit part corresponds to the first type of content, the bit-rate setting means sets the first bit rate as a bit rate for the processing unit part, and when the processing unit part corresponds to the second type of content, the bit-rate setting means sets the second bit rate lower than the first bit rate as a bit rate for the processing unit part.

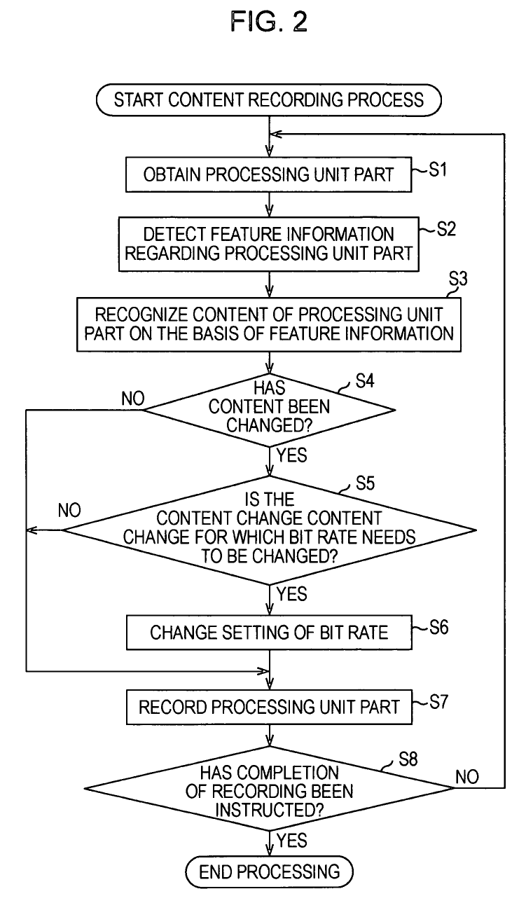

A recording method (for example, a content recording process in FIG. 2) according to an embodiment of the present invention for use with a recording apparatus (for example, a recording apparatus 11 in FIG. 1) for recording one or more pieces of content provided as stream data on a recording medium includes the steps of: variably setting (for example, steps S4 to S6 in FIG. 2) a bit rate when a processing unit part is recorded on the recording medium in accordance with content in the processing unit part within the one or more pieces of content for each processing unit part for which a recording process is performed on the recording medium within the stream data; and performing control (for example, step S7 in FIG. 2) so that the stream data is sequentially recorded on the recording medium for each processing unit part at each bit rate that is variably set for each processing unit part.

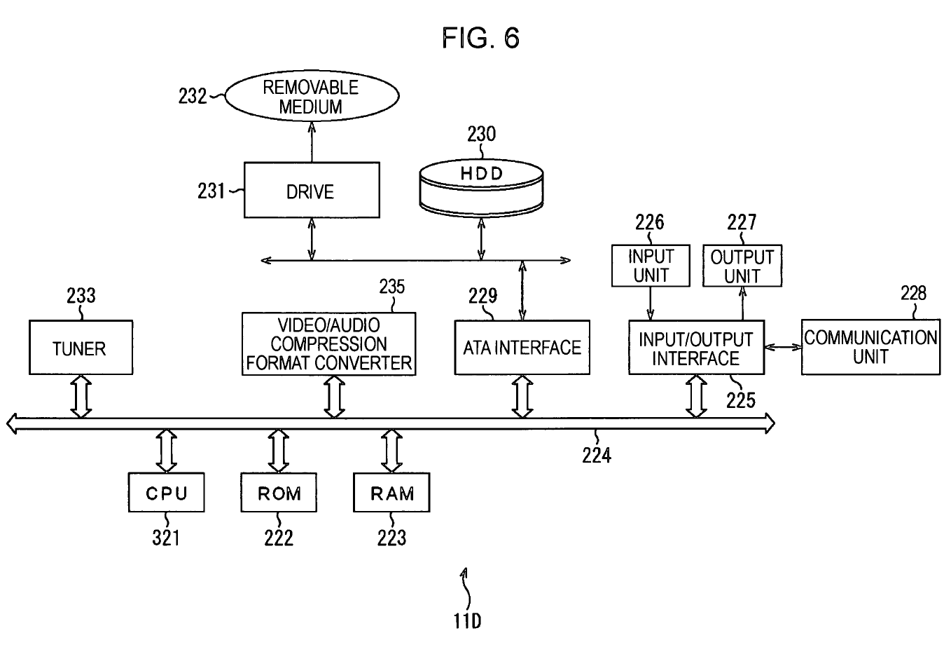

The program according to an embodiment of the present invention is a program for use with the recording method according to an embodiment of the present invention, and is executed by a computer including, for example, a CPU 321 shown in FIG. 6.

Embodiments of the present invention will be described below with reference to the drawings.

FIG. 1 is a functional block diagram showing an example of the functional configuration of a recording apparatus to which the present invention is applied.

In other words, in the functional block diagram of FIG. 1, functions necessary to perform processing to which the present invention is applied among various functions of a recording apparatus 11 are considered. Such functions are classified into several predetermined functions, and only the functional blocks having each classified predetermined function are shown. That is, the illustration of functional blocks having other functions possessed by the recording apparatus 11, for example, a function of providing a user interface and a display function, is omitted.

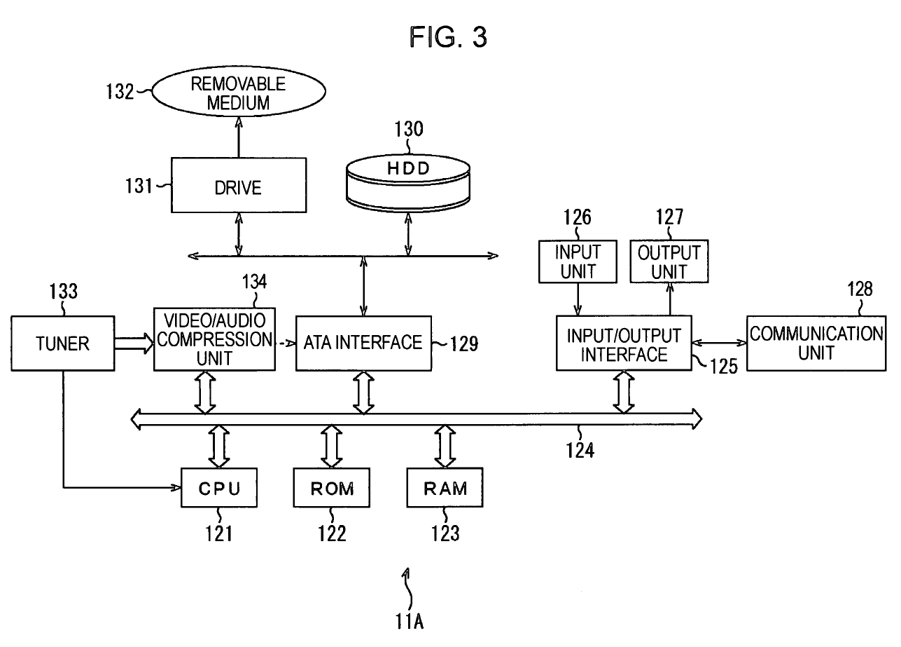

The functional blocks in FIG. 1 may be formed of a single hardware body, may be formed of a single software body, or may be formed of a combination thereof. Furthermore, a plurality of functional blocks may be collected as one functional block, or one functional block may be divided into functional blocks of a smaller unit. In other words, as long as the recording apparatus 11 of FIG. 1 has each function possessed by each functional block, the forms to be embodied are not particularly limited, and various forms can be taken as shown in FIGS. 3 to 6 (to be described later).

In the example of FIG. 1, the recording apparatus 11 is configured to include a content obtaining unit 21, a feature information detector 22, a content recognition unit 23, a bit-rate setting unit 24, and a recording controller 25 so that one or more pieces of content provided externally in the form of stream data are sequentially recorded.

In the example of FIG. 1, a recording medium 31 is shown in the solid line indicating the range of the recording apparatus 11. The reason for this is to show that the recording medium 31 may be installed inside the recording apparatus 11, for example, as a hard disk contained in a hard disk drive (HDD), or may be freely removed from the recording apparatus 11 as a removable medium such as an optical disc. In other words, the recording medium 31 is not particularly limited as long as it is in a form capable of recording content.

Here, content refers to content created by creative activities of a human being in a broad sense. Examples of content are movie, music, drama, literature, photographs, comics, animation, computer games, characters, figures, color, audio, action, video, a combination of these, and a program for providing information related to these via a computer. Here, content mainly containing video is referred to as video content. The video content can be broadly classified into still image content mainly containing still images and moving image content mainly containing moving images. In the following, a description will be given while considering moving image content. That is, a description will be given under the assumption that the recording apparatus 11 records moving image content on the recording medium 31.

However, in this specification, so-called content data, that is, content created by creative activities of a human being, which are rendered to be processable by an apparatus, for example, content rendered to be an electrical signal or fixed in a memory is collectively referred to as content without particularly being distinguished. That is, here, a collection of data of each frame or field constituting a moving image will also be referred to as moving image content.

Furthermore, in this embodiment, the recording apparatus 11 handles broadcast/distribution programs, movies, and the like among the moving image content as objects to be recorded. When such a broadcast/distribution program, movie, or the like is provided to the recording apparatus 11 in the form of stream data, in general, it is not provided alone, and a plurality of broadcast/distribution programs, and CMs (Commercial Messages) are often presented to the viewer before and after the broadcast/distribution program and in the intervals between the broadcast/distribution programs continuously with respect to time in accordance with a program schedule of a broadcast station in a predetermined order. Therefore, stream data provided to the recording apparatus 11 in this embodiment is assumed to contain data about broadcast/distribution programs, movies, and other types of broadcast content, such as CMs (Commercial Messages).

Accordingly, in the following, broadcast/distribution programs, movies, and the like will be referred to as “main part sections” as appropriate among such stream data. Furthermore, parts other than the “main part sections”, that is, parts of CMs, which are inserted in the intervals between the “main part sections” and before and after the “main part sections” will be referred to as “CM sections”. Then, “main part sections” and “CM sections” are handled as different types of content. That is, parts other than the “main part sections”, in general, are often sections in which, for example, a plurality of CMs in units of 30 seconds or 1 minute are inserted. That is, for example, for a television broadcast transmitted by a predetermined broadcast station, a “CM section” may be said to be a section in which a plurality of CMs in units of 30 seconds or 1 minute continuously flow with respect to time, that is, to be a collection of a plurality of CMs or the like. Therefore, although a CM or the like can be regarded as one piece of content, here, the type of CM or the like is not particularly distinguished, and a “CM section”, which is a collection of CMs, is regarded as one type of content.

In other words, also when only one “main part section” is provided in the form of a single body as in download distribution, of course, the present invention can be applied. However, in order to facilitate the understanding of the features of the present invention even further, a description will be given below by assuming a case in which, as in a television broadcast by a predetermined broadcast station, a plurality of pieces of content (“main part sections” and “CM section” referred to herein) are each broadcast continuously with respect to time. That is, in the following, it is assumed that stream data composed of a plurality of pieces of content (“main part sections” and “CM sections” referred to herein) arranged continuously with respect to time are provided to the recording apparatus 11.

In this case, a content obtaining unit 21 obtains predetermined processing unit parts provided at present among the stream data. That is, the content obtaining unit 21 sequentially obtains the stream data for each processing unit part.

Here, the processing unit part means a part that can become a unit for processing when the processing is simply performed on stream data. Which part should be used as a processing unit can be determined as desired by a designer or the like. For example, units, such as frames and fields, may be adopted as processing unit parts, and each division part that can be obtained when stream data is divided at predetermined time intervals may be adopted as a processing unit part. Furthermore, in the latter example, by setting a division time to as small a time as possible, processing performed for each processing unit part can be made not to be a discrete process, but to be a practically continuous process.

A feature information detector 22 detects feature information for the processing unit part obtained by the content obtaining unit 21.

It is sufficient for the feature information to be information that can be extracted or detected from each processing unit part, and information with which the content corresponding to the processing unit part can be determined or information with which the presence or absence of a difference in the content corresponding to each of the preceding and following processing unit parts can be determined, and the form thereof is not particularly limited. However, the difference in the content differs according to the type of content used as a reference with which a bit rate at the time of recording is variably set by a bit-rate setting unit 24 (to be described later). For example, in this embodiment, two types of “main part section” and “CM section” are used as types of content. Therefore, it is sufficient for the feature information to be information with which the difference in the two types of content can be determined. Further details of the feature information will be described in conjunction with the description of the bit-rate setting unit 24.

A content recognition unit 23 recognizes content of the processing unit part obtained by the content obtaining unit 21 on the basis of the feature information detected by the feature information detector 22. For example, in this embodiment, the content recognition unit 23 recognizes as to which one of the “main part section” and the “CM section” the processing unit part corresponds to.

The bit-rate setting unit 24 variably sets the bit rate when the processing unit part obtained by the content obtaining unit 21 is recorded according to the content recognized by the content recognition unit 23.

A recording controller 25 performs control so that the processing unit part obtained by the content obtaining unit 21 is recorded on the recording medium 31 at the bit rate that has been variably set by the bit-rate setting unit 24.

In other words, while the processing unit part corresponding to the same content is being provided, a same first bit rate is continued to be set by the bit-rate setting unit 24, that is, the setting of the bit rate is not changed. Under the control of the recording controller 25, each processing unit part is successively recorded on the recording medium 31 at the first bit rate. Thereafter, at the stage in which a processing unit part corresponding to different content is provided, a second bit rate differing from the first bit rate is set by the bit-rate setting unit 24, that is, the setting of the bit rate is changed. Under the control of the recording controller 25, the processing unit part corresponding to the different content is recorded on the recording medium 31 at the second bit rate.

Therefore, the content recognized by the content recognition unit 23 is not particularly limited. It is preferable that bit rates at the time of recording be associated with content. That is, it is preferable that, while considering the purpose of the change of the bit rate, N (N is an integer value from 2 to infinity) types of content that can be classified on the basis of feature information are defined in advance, and a bit rate appropriate for the content is assigned in advance to each of the N types of the defined content correspondingly. Here, the fact that N is infinity means there is a possibility of varying the bit rate not discretely but continuously.

While showing several specific examples, the recording apparatus 11 of FIG. 1 will be described further.

For example, in this embodiment, as types of content, as described above, two types of “main part section” and “CM section” are defined and therefore, the two types can be used as content. In this case, two processing unit parts corresponding to the “main part section” are processing unit parts of the same content and similarly, two processing unit parts corresponding to the “CM section” are processing unit parts of the same content. In comparison, one processing unit part corresponding to the “main part section” and one processing unit part corresponding to the “CM section” are processing unit parts differing from each other. In this case, when the fact that, in general, for example, a “CM section” has a degree of importance lower than a “main part section” is considered, a first bit rate is assigned as a bit rate when a “main part section” is recorded, and a second bit rate lower than the first bit rate can be assigned as a bit rate when a “CM section” is recorded.

Then, for the feature information, information with which a “CM section” can be detected can be used. In other words, it is possible to adopt a predetermined CM section detection method, and information used by the adopted method may be adopted as feature information.

Here, the predetermined CM section detection method means an adopted predetermined method among various methods, and at the stage before adoption, of course, the CM section detection method can be adopted from among any desired CM section detection methods. That is, as a CM section detection method, a well-known method may be adopted and also, a new method which will appear in the future may be adopted. In other words, the CM section detection method is not an important element. Therefore, at this point, only one well-known method that can be adopted will be introduced.

That is, in general, a broadcast program and a CM contain video and also audio. It is possible for the content obtaining unit 21 to obtain a video signal and also an audio signal as signals constituting a broadcast program and a CM. Furthermore, for the audio signal, several audio modes exist. There are features such that an audio mode for CMs is often in a stereo mode, whereas an audio mode for broadcast programs is often in a monaural mode or in an audio multiplex mode. Accordingly, the feature information detector 22 detects audio mode information on a processing unit part as feature information, with the result that the content recognition unit 23 can recognize that a processing unit part in a stereo mode is a “CM section”, that is, can detect a CM section. Details of such a CM section detection method are disclosed in, for example, Japanese Patent No. 2858758.

Even when, in addition to such a CM section detection method, any method is adopted, as processing at a stage subsequent to the content recognition unit 23, the following processing is performed. That is, each processing unit part recognized as a “main part section” is recorded on the recording medium 31 at a first bit rate, whereas each processing unit part recognized as a “CM section” is recorded on the recording medium 31 at a second bit rate lower than the first bit rate.

That is, for example, when stream data is composed of broadcast content (various kinds of broadcast programs, various kinds of CMs, and the like) from a predetermined broadcast station, in the case that a predetermined broadcast program is being broadcast, the content recognition unit 23 recognizes each processing unit part to be a “main part section”. Therefore, the setting of the bit rate at the time of recording is continued to be maintained at the first bit rate by the bit-rate setting unit 24, that is, the setting of the bit rate is not changed, and under the control of the recording controller 25, each processing unit part (each part constituting the predetermined broadcast program) is successively recorded on the recording medium 31 at the first bit rate.

Then, when the broadcast content is changed to a CM or the like at a predetermined timing in the intervals of a predetermined broadcast program or after a predetermined broadcast program, whereas the processing unit part proceeding to the predetermined timing is recognized as a “main part section” by the content recognition unit 23, the content recognition unit 23 recognizes the processing unit part after the predetermined timing to be a “CM section”. At such a time, the bit-rate setting unit 24 changes the setting of the bit rate at the time of recording from the first bit rate to the second bit rate lower than the first bit rate, and under the control of the recording controller 25, the recording of the processing unit part (each part constituting a CM) on the recording medium 31 is started at the second bit rate.

Thereafter, when a CM is being broadcast, the content recognition unit 23 recognizes each processing unit part to be a “CM section”. Therefore, the bit-rate setting unit 24 continues to maintain the setting of the bit rate at the time of recording at the second bit rate. That is, the setting of the bit rate is not changed, and under the control of the recording controller 25, each processing unit part (each part constituting a CM) is successively recorded on the recording medium 31 at the second bit rate.

Next, when the broadcast content is changed from the CM to a predetermined broadcast program or a next broadcast program at a predetermined timing, whereas the content recognition unit 23 recognizes the processing unit part before the predetermined timing to be a “CM section”, the processing unit part after the predetermined timing is recognized to be a “main part section”. At such a time, the bit-rate setting unit 24 changes the setting of the bit rate at the time of recording from the second bit rate to the original first bit rate. Then, under the control of the recording controller 25, the recording of the processing unit part (part constituting a predetermined broadcast program or a next broadcast program) on the recording medium 31 is started at the first bit rate.

Thereafter, during the time until a still next the CM is broadcast, that is, while the predetermined broadcast program or the next broadcast program is being broadcast, the content recognition unit 23 recognizes each processing unit part to be a “main part section”. Therefore, the bit-rate setting unit 24 continues to maintain the setting of the bit rate at the time of recording at the first bit rate. That is, the setting of the bit rate is not changed, and under the control of the recording controller 25, each processing unit part (each part constituting the predetermined broadcast program or the next broadcast program) is successively recorded on the recording medium 31 at the first bit rate.

In the manner described above, when the recording apparatus 11 shown in FIG. 1 records, for example, broadcast content on the recording medium 31, it is possible to make a determination as to whether the bit rate should be increased or may be low for each processing unit part. Then, on the basis of this determination result, it is possible for the recording apparatus 11 to select an optimum bit rate by varying (including maintaining at the same) the bit rate at the time of recording for each processing unit part and to record the broadcast program on the recording medium 31. That is, in the above-described example, it is determined that regarding each processing unit part constituting a “main part section”, such as a broadcast program, the bit rate should be increased, the first bit rate is selected, and the processing unit part is recorded on the recording medium 31. On the other hand, it is determined that regarding each processing unit part constituting a “CM section”, such as a CM, the bit rate should be decreased, a second bit rate lower than the first bit rate is selected, and the processing unit part is recorded on the recording medium 31.

As a result, in spite of the fact that a “CM section” has been recorded, the reduction of a capacity necessary for recording within the limited capacity of the recording medium 31 is made possible.

Furthermore, in spite of the fact that a “CM section” has been recorded, even if there are constraints on the capacity limitation of the recording medium 31, it is possible to record the “main part section” at a high quality.

Since “CM sections” have been recorded without being cut, when it is desired to view a “CM section”, it is possible to view it at any time.

Even if the detection of the “CM section” fails, the processing unit part is recognized as a “main part section”. That is, the “CM section” for which detection has failed is simply recorded at the same bit rate (the first bit rate in the above-described example) as that of the “main part section”. Therefore, as long as there is available space on the recording medium 31, since all the content has been recorded and remains, it is possible to view all the content at any time.

Here, as a method of changing the bit rate by the bit-rate setting unit 24, a method of simply changing the bit rate for recording can be adopted. In addition, without particularly being limited to such a method, a method of changing a screen resolution (picture size), a method of changing a compression format, and others can be adopted.

That is, in the present invention, it is possible to dynamically change the bit rate for recording while considering the change of the screen resolution (picture size) and the compression format as options. As a result, it is possible to decrease the recording capacity consumed by a part with a low degree of importance under a condition in which the recording capacity of the recording medium 31 is limited.

Furthermore, for example, in a case in which the remaining capacity of the recording medium 31 is limited and a broadcast program is scheduled to be stored therein, it is possible for the recording apparatus 11 to predict the length of the “CM section” and adjust the recording capacity necessary for the entire recording under the assumption that a low bit rate is set in accordance with the amount of the length of the “CM section”. As a result, it is possible to record a “main part section” with higher quality on the recording medium 31 having limited recording capacity.

The various advantages that have been described above are difficult to obtain even if the related art is adopted. This is because, as described above in the “Description of the Related Art” section, in the related art, all the “CM sections” referred to herein are not recorded. Although description has been omitted in the “Description of the Related Art” section, in the related art, a necessary recording capacity is calculated from the recording time of the entire stream data referred to herein, that is, the entire recording time of not only the “main part sections” but also the “CM sections”, and even the approach to improving the image quality of the “main part section” by reducing the capacity necessary for recording a “CM section” has not existed to date.

An example has been described above in which, when a plurality of types of content (in the above-described example, two types of “main part section” and “CM section”) are continuously provided in the form of stream data to the recording apparatus 11, a plurality of types of content are recorded on the recording medium 31 at a bit rate appropriate for each of the plurality of types of content. That is, the setting of a bit rate in the same type of content is fixed.

However, the variable unit of the setting of the bit rate in the present invention is not limited for each of such type of content. It is also possible to perform recording on the recording medium 31 while varying the bit rate in one content.

For example, a case in which only predetermined one “main part section” is to be recorded on the recording medium 31 is considered. In such a case, the “main part section” is often composed of various scenes. However, from the viewpoint of a viewer, the degree of importance of all the scenes in the “main part section” is not the same and often importance is placed on a so-called highlight scene, for example, an event scene, such as, for example, a goal scene in a soccer game. There is a case in which a user has a desire to record such a highlight scene with image quality higher than the other scenes.

In order to respond to such a demand, it is possible for the recording apparatus 11 to perform, for example, the processing described below.

That is, two types of “highlight scene” and “general scene” can be defined as content. In this case, two processing unit parts corresponding to the “highlight scene” are processing unit parts of the same content, and similarly, two processing unit parts corresponding to the “general scene” are processing unit parts of the same content. In comparison, one processing unit part corresponding to the “highlight scene” and one processing unit part corresponding to the “general scene” are processing unit parts of mutually differing content. In this case, in order to respond to the above-described demand, for example, the first bit rate can be assigned as a bit rate at the time of recording a “general scene”, and the second bit rate higher than the first bit rate can be assigned as a bit rate at the time of recording a “highlight scene”.

As feature information, information with which a “highlight scene” can be detected can be used. In other words, a predetermined highlight scene detection method can be used, and the information used by the adopted method may be used as feature information.

Here, the predetermined highlight scene detection method means a predetermined method adopted from among various methods. Of course, at a stage before adoption, it is possible to adopt any highlight scene detection method. That is, as a highlight scene detection method, a well-known method may be adopted and also, a new method which will appear in the future may be adopted. In other words, the highlight scene method is not an important element of the present invention. Accordingly, in order to avoid duplication of description, an example of a highlight scene detection method is omitted herein.

Even when any highlight scene detection method is adopted, the processing described below is performed as processing from the content recognition unit 23 and subsequent stages. That is, each processing unit part recognized as a “general scene” is recorded on the recording medium 31 at a first bit rate, whereas each processing unit part recognized as a “highlight scene” is recorded on the recording medium 31 at a second bit rate higher than the first bit rate.

That is, when “main part sections” to be recorded are sequentially provided as stream data to the recording apparatus 11, in general, the content recognition unit 23 recognizes each processing unit part to be a “general scene”. At such a time, the bit-rate setting unit 24 continues to maintain the setting of the bit rate at the time of recording at the first bit rate. That is, the setting of the bit rate is not changed, and under the control of the recording controller 25, each processing unit part (part of a “main part section”) is successively recorded on the recording medium 31 at the first bit rate.

Then, when the processing unit part is changed to a highlight scene, such as a goal scene, at a predetermined timing, the content recognition unit 23 recognizes the processing unit part before the predetermined timing to be a “general scene”, whereas the processing unit part after the predetermined timing is recognized to be a “highlight scene”. At such a time, the bit-rate setting unit 24 changes the setting of the bit rate at the time of recording from the first bit rate to the second bit rate. Under the control of the recording controller 25, the recording of the processing unit part (part of the “main part section” and corresponding to the highlight scene) on the recording medium 31 is started at the second bit rate.

Thereafter, when the highlight scene continues, the content recognition unit 23 recognizes each processing unit part as a “highlight scene”. Therefore, the bit-rate setting unit 24 continues to maintain the setting of the bit rate at the time of recording at the second bit rate. That is, the setting of the bit rate is not changed, and under the control of the recording controller 25, each processing unit part (part of the “main part section” and corresponding to a highlight scene) is successively recorded on the recording medium 31 at the second bit rate.

Then, when the highlight scene is changed to another scene (a general scene), whereas the content recognition unit 23 recognizes the processing unit part before the predetermined timing as a “highlight scene”, the processing unit part after the predetermined timing is recognized as a “general scene”. At such a time, the bit-rate setting unit 24 changes the setting of the bit rate at the time of recording from the second bit rate to the original first bit rate. Under the control of the recording controller 25, the recording of the processing unit part (part of the “main part section”) on the recording medium 31 is started at the first bit rate.

Thereafter, until the next highlight scene appears, the content recognition unit 23 recognizes each processing unit part as a “general scene” and therefore, the bit-rate setting unit 24 continues to maintain the setting of the bit rate at the time of recording at the first bit rate. That is, the setting of the bit rate is not changed, and under the control of the recording controller 25, each processing unit part (part of the “main part section”) is successively recorded on the recording medium 31 at the first bit rate.

In the above-described example, to facilitate understanding, the number of levels of the variable setting of the bit rate is set at only two. That is, of course, the number of levels of the variable setting of the bit rate is not limited to two, and can be set at a larger number of levels, and thus setting of an infinite number of levels, that is, continuous variable setting, is also easily possible.

FIG. 2 is a flowchart illustrating an example of a content recording process of the recording apparatus 11.

In step S1, the content obtaining unit 21 obtains, as a processing unit part, a predetermined portion that is provided at present within, for example, stream data containing one or more pieces of content.

In step S2, the feature information detector 22 detects feature information on the processing unit part obtained in the process of step S1.

In step S3, on the basis of the feature information detected in the process of step S2, the content recognition unit 23 recognizes the content of the processing unit part obtained in the process of step S1.

In step S4, the bit-rate setting unit 24 compares the content recognized in the process of step S3 at this time with the content recognized in the process of step S3 at the previous time and determines whether or not the content has been changed.

When the content has not been changed, since the setting of the bit rate does not need to be changed, the answer in the process in step S4 is determined to be NO, and the process proceeds to step S7. In step S7, the recording controller 25 causes the processing unit part obtained in the process of step S1 at this time to be recorded on the recording medium 31 at the same bit rate as that of the processing unit part at the previous time. Thereafter, the process proceeds to step S8. Processing of step S8 and subsequent steps will be described later.

In comparison, when the content has been changed, since the setting of the bit rate may have been changed, the answer in the process in step S4 is determined to be YES, and the process proceeds to step S5.

In step S5, the bit-rate setting unit 24 determines whether or not the content change is a content change for which the bit rate needs to be changed.

That is, regarding content changes, as described above, content changes of various patterns can exist. Therefore, there is no particular need to change the bit rate with respect to the change of the content of all patterns, and it is also possible to limit a pattern with which the bit rate is changed.

For example, when stream data composed of broadcast content from a broadcast station is to be recorded, as patterns of content changes, as described above, in addition to a first change pattern from a “main part section” to a “CM section” and a second change pattern from a “CM section” to a “main part section”, content changes in one predetermined broadcast program (one “main part section”) exist. That is, a third change pattern from a “general scene” to a “highlight scene”, and a fourth change pattern from a “highlight scene” to a “general scene” exist.

Here, for example, the purpose of the content recording process is assumed to be a purpose of performing recording with the bit rate decreased for only the “CM section”. That is, it is assumed that, up to the middle of a predetermined one broadcast program (one “main part section”), there is no need to vary the bit rate. Under this assumption, even if there is a content change in accordance with the third change pattern and the fourth change pattern, those content changes may be said to be content changes for which the change of the bit rate is unnecessary. Therefore, in such a case, the answer in the process in step S5 is determined to be NO, and the process proceeds to step S7. In step S7, the recording controller 25 causes the processing unit part obtained in the process of step S1 at this time to be recorded on the recording medium 31 at the same bit rate as that of the processing unit part at the previous time. Thereafter, the process proceeds to step S8. Processing of step S8 and subsequent steps will be described later.

In comparison, under the above-described assumption, when there is a content change in accordance with the first change pattern or the second change pattern, the bit rate needs to be changed. Therefore, in such a case, the answer in the process in step S5 is determined to be YES, and the process proceeds to step S6.

In step S6, the bit-rate varying unit 24 changes the setting of the bit rate.

For example, in the case of the first change pattern from the “main part section” to the “CM section”, the bit rate is changed from the first bit rate to the second bit rate lower than that. In comparison, in the case of the second change pattern from the “CM section” to the “main part section”, the bit rate is changed from the second bit rate to the first bit rate higher than that. That is, the bit rate is returned to the original first bit rate.

In step S7, the recording controller 25 causes the processing unit part obtained in the process of step S1 at this time to be recorded on the recording medium 31 at the bit rate whose setting has been changed in the process of step S6.

In step S8, the recording apparatus 11 determines whether or not the completion of the recording has been instructed.

When the completion of the recording has not been instructed, the answer in the process in step S8 is determined to be NO. The process then returns to step S1, and step S1 and subsequent steps are repeated. That is, the following processing is repeated in which a part that is provided next within stream data is made to be a new processing unit part, processing of steps S1 to S7 is performed on the new processing unit part, an appropriate bit rate is set (including maintaining the setting), and the new processing unit part is recorded on the recording medium 31.

Thereafter, when the completion of the recording is instructed, the answer in the process in step S8 is determined to be YES, and the content recording process ends.

Next, a description will be given, with reference to FIGS. 3 to 6, examples of various kinds of hardware configuration of the recording apparatus 11 shown in FIG. 1.

A recording apparatus 11A in an example of FIG. 3 is an embodiment of an analog-broadcast-compatible recording apparatus. That is, it is possible for the recording apparatus 11A in the example of FIG. 3 to record broadcast content of analog broadcasts, that is, various kinds of broadcast programs, CMs, and the like.

In FIG. 3, a CPU (Central Processing Unit) 121 performs various kinds of processing in accordance with a program recorded in a ROM (Read Only Memory) 122 or a program loaded from a HDD (Hard Disk Drive) 130 into a RAM (Random Access Memory) 123. In the RAM 123, data and the like necessary for the CPU 121 to execute various kinds of processing is also stored as appropriate.

The CPU 121, the ROM 122, and the RAM 123 are interconnected with one another via a bus 124. Also, an input/output interface 125, an ATA (AT Attachment) interface 129, and a video/audio compression unit 134 are connected to the bus 124.

An input unit 126 for the user to perform various kinds of operations, an output unit 127 formed of a display or the like for displaying the operation content or the like, and a communication unit 128 formed of a modem, a terminal adaptor, and the like are connected as necessary to the input/output interface 125. The communication unit 128 controls communication performed with other apparatuses (not shown) via a network including the Internet.

The ATA interface 129 is formed of an ATA interface, an interface with a recording device, which is similar to the ATA interface, for example, IEEE (The Institute of Electrical and Electronics Engineers, Inc) 1394, a fibre channel, or the like. In the example of FIG. 3, the HDD 130, and a drive 131 for controlling reading from and writing into a removable medium 132 such as a Blu-ray (trademark) disc or a DVD (Digital Versatile Disk) are connected to the ATA interface 129.

That is, in the example of FIG. 3, as the recording medium 31 of FIG. 1, the HDD 130 and the removable medium 132 are used. Therefore, in the example of FIG. 3, it is possible for the recording apparatus 11A to record broadcast content of an analog broadcast in at least one of the HDD 130 and the removable medium 132.

When a computer program is contained on the removable medium 132, the computer program is read by the drive 131 as necessary and is installed into the HDD 130.

A tuner unit 133 receives an analog broadcast and provides the broadcast content in the form of an analog video signal and an analog audio signal to a video/audio compression unit 134.

Furthermore, the tuner unit 133 provides information that can serve as feature information, for example, audio mode information with which a “CM section” is detected, to the CPU 121. On the basis of the feature information, the CPU 121 can recognize broadcast content of an analog broadcast for each processing unit part. For example, in the example of FIG. 3, the CPU 121 recognizes which one of the “main part section” and the “CM section” each of the processing unit parts constituting the broadcast content of an analog broadcast is. In other words, the CPU 121 performs the detection of the “CM section”.

As described above, in the example in FIG. 3, the tuner unit 133 corresponds to the content obtaining unit 21 of FIG. 1, and the CPU 121 (including predetermined software executed by the CPU 121) corresponds to the feature information detector 22 and the content recognition unit 23. The correspondence is only an example and in addition, for example, the video/audio compression unit 134 may correspond to the feature information detector 22 and the content recognition unit 23.

The video/audio compression unit 134 performs a compression coding process in accordance with a predetermined compression format, for example, an MPEG (Moving Picture Experts Group) method on broadcast content of an analog broadcast provided in the form of an analog signal from the tuner unit 133, and provides the broadcast content via the bus 124 or in a direct manner (see the dotted line) to the ATA interface 129. The broadcast content of an analog broadcast provided to the ATA interface 129, that is, the compression-coded content data, is recorded in the HDD 130 or on the removable medium 132.

The setting of the bit rate when an output is made from the video/audio compression unit 134, that is, the setting of the recording in the HDD 130 or on the removable medium 132, is performed by the CPU 121. That is, the CPU 121 sets the first bit rate with regard to the part determined to be a “main part section” among the processing unit parts constituting broadcast content of an analog broadcast, and sets the second bit rate lower than the first bit rate with regard to a part determined to be a “CM section”.

As described above, in the example of FIG. 3, the CPU 121 (including predetermined software executed by the CPU 121) corresponds to the bit-rate setting unit 24 of FIG. 1, and the video/audio compression unit 134 and the ATA interface 129 (the CPU 121 may be included) correspond to the recording controller 25. This correspondence is only an example and in addition, for example, the video/audio compression unit 134 may correspond to the bit-rate setting unit 24.

Here, as a method for “setting the second bit rate lower than the first bit rate”, as described above, a method in which the bit rate for recording is simply decreased, a method in which the screen resolution (picture size) is decreased, more specifically, the screen resolution is changed from 720×480 to 352×240, or a method in which the compression format is changed from MPEG2 to MPEG4 AVC, can be adopted.

When it is determined that the “CM section” ends and a “main part section” is reached, the CPU 121 performs the original recording setting of the bit rate of the video/audio compression unit 134, that is, the setting of returning the setting from the second bit rate to the first bit rate. As a method of implementing the setting in this case, a method reverse to the method adopted as a method of implementing “setting the second bit rate lower than the first bit rate” may be adopted.

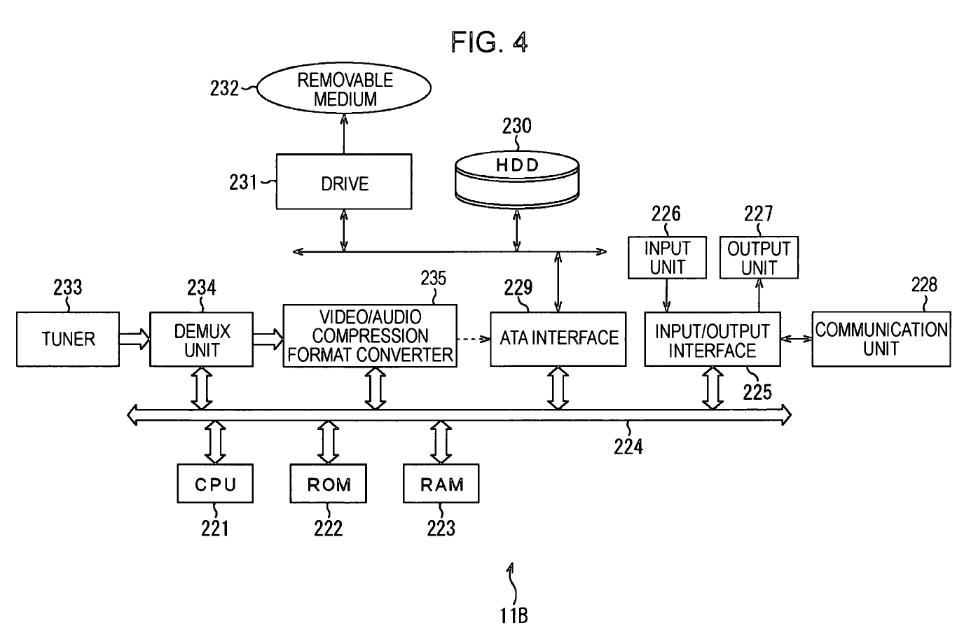

In contrast with the analog-broadcast-compatible recording apparatus 11A in the example of FIG. 3, a recording apparatus 11B in the example of FIG. 4 is an embodiment of a digital-broadcast-compatible recording apparatus. That is, the recording apparatus 11B in the example of FIG. 4 can record broadcast content of digital broadcasts, that is, various kinds of broadcast programs, CMs, and the like.

In FIG. 4, a CPU 221 performs various kinds of processing in accordance with a program recorded in a ROM 222 or a program loaded from an HDD 230 to a RAM 223. Data necessary for the CPU 221 to perform various kinds of processing is also stored in the RAM 223 as appropriate.

The CPU 221, the ROM 222, and the RAM 223 are interconnected with one another via a bus 224. Furthermore, an input/output interface 225, an ATA interface 229, a DEMUX unit 234, and a video/audio compression format converter 235 are also connected to the bus 224.

An input unit 226 for the user to perform various kinds of operations, an output unit 227 formed of a display and the like for displaying the operation content and the like, and a communication unit 228 formed of a modem, a terminal adaptor, and the like are connected to the input/output interface 225 as necessary. The communication unit 228 controls communication performed with other apparatuses (not shown) via a network including the Internet.

In the example of FIG. 4, the HDD 230, and a drive 231 for controlling reading into and writing from a removable medium 232, such as a Blu-ray (trademark) disc or a DVD, are connected to the ATA interface 229.

That is, in the example of FIG. 4, as the recording medium 31 of FIG. 1, the HDD 230 and the removable medium 232 are used. Therefore, in the example of FIG. 4, it is possible for the recording apparatus 11B to record broadcast content of a digital broadcast in at least one of the HDD 230 and the removable medium 232.

When a computer program is contained on the removable medium 232, the computer program is read by the drive 231 and is installed into the HDD 230 as necessary.

A tuner unit 233 receives a digital broadcast, and provides the broadcast content to the DEMUX unit 234 in the form of compression-coded data in accordance with a predetermined compression format, for example, in the form of an MPEG signal. The DEMUX unit 234 separates an MPEG signal from the tuner unit 133 into a video signal, an audio signal, and other information signals (signals of program information, organization change information, etc.), and provides the signals to the video/audio compression format converter 235.

The video/audio compression format converter 235 converts (including maintaining the same format) the compression format of the broadcast content of a digital broadcast provided in such a manner that the broadcast content is separated into various kinds of signals by the DEMUX unit 234, and provides the broadcast content after the compression format is converted to the ATA interface 229 via the bus 224 or in a direct manner (see the dotted line). The broadcast content of the digital broadcast provided to the ATA interface 229, that is, the compression-coded content data after the compression format is converted, is recorded in the HDD 230 or on the removable medium 232.

That is, the broadcast content of a digital broadcast at the time of a broadcast has been subjected to a compression coding process in accordance with some kind of compression format. Therefore, in the form as is, it is difficult to decrease the bit rate. Therefore, the video/audio compression format converter 235 performs conversion of the compression format, thereby decreasing the bit rate. As a method of decreasing the bit rate, for example, in addition to a method of decreasing the bit rate while being maintained in the same format as that at the time of the broadcast, a method of changing the picture size (screen resolution), for example, a method of changing a picture size of 720×480 to a picture size of 352×240, or a method of changing the compression format, for example, a method of changing the compression format from MPEG2 to MPEG4 AVC, can be adopted.

That is, in the example of FIG. 4, for example, the setting of the bit rate is changed in the following manner.

The CPU 221 obtains, as feature information, information on the video signal, program information, organization change information, and the like from the DEMUX unit 234. Then, on the basis of the feature information, the CPU 221 recognizes the broadcast content of the digital broadcast for each processing unit part. More specifically, for example, a first recognition to a third recognition described below are performed.

The first recognition refers to a recognition as to which one of a “main part section” and a “CM section” the processing unit part is.

The second recognition refers to a recognition such that, when the processing unit part is a “main part section”, how far in the future the processing unit part will be changed to a “CM section”.

The third recognition refers to a recognition such that, when the processing unit part is a “CM section”, how far in the future the processing unit part will be changed to a “main part section”.

Then, when the CPU 221 detects the change from the “main part section” to the “CM section”, the CPU 221 changes the setting of the video/audio compression format converter 235 so that each processing unit part after detection is recorded at a low bit rate (second bit rate).

Here, as a method of changing the setting of the video/audio compression format converter 235, which is performed for recording at a low bit rate, as also stated above, a method of simply decreasing the bit rate for recording may be adopted. In addition, for example, a method of changing the screen resolution (picture size) from 720×480 to 352×240 or the like, or a method of changing the compression format from MPEG2 to MPEG4 AVC, can be adopted.

On the other hand, when the change from the “CM section” to the “main part section” is detected, the CPU 221 changes the setting of the video/audio compression format converter 235 with regard to each processing unit part after the detection, so that recording in the original recording format, that is, at the original bit rate (first bit rate), is made possible. In this case, when the case of being a digital broadcast is considered, the stream data received by the tuner unit 233 may be recorded in the form as is in the HDD 230 or the like without passing through the video/audio compression format converter 235.

As described above, in the example of FIG. 4, the tuner unit 233 corresponds to the content obtaining unit 21 of FIG. 1, the DEMUX unit 234 and the CPU 221 (including predetermined software executed by the CPU 221) correspond to the feature information detector 22, the CPU 221 (including predetermined software executed by the CPU 221) corresponds to the content recognition unit 23 and the bit-rate setting unit 24, and the video/audio compression format converter 235 and the ATA interface 229 (including the CPU 221) correspond to the recording controller 25. The correspondence is only an example. In addition, for example, the video/audio compression format converter 235 may correspond to the content recognition unit 23 and the bit-rate setting unit 24.

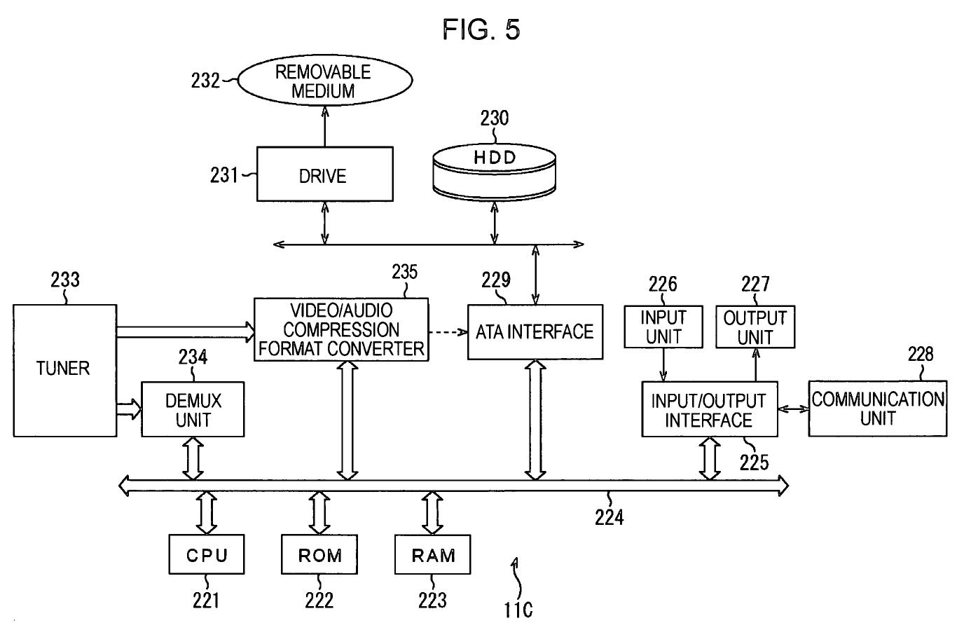

Furthermore, as an embodiment of the digital-broadcast-compatible recording apparatus, in addition, for example, the configuration shown in FIGS. 5 and 6 can be adopted. Components in FIG. 5, which correspond to the components shown in FIG. 4, are designated with the same reference numerals, and accordingly, descriptions thereof are omitted as appropriate.

When the recording apparatus 11B in the example of FIG. 4 is compared with a recording apparatus 11C in the example of FIG. 5, both include identical components. However, the video/audio compression format converter 235 in the example of FIG. 4 does not have a function of directly receiving a signal from the tuner unit 233, and therefore is configured to receive an output signal of the DEMUX unit 234. In comparison, the video/audio compression format converter 235 in the example of FIG. 5 has a function of directly receiving a signal from the tuner unit 233.

Components in FIG. 6, which correspond to the components shown in FIG. 4, are designated with the same reference numerals, and accordingly, descriptions thereof are omitted as appropriate.

When the recording apparatus 11B in the example of FIG. 4 is compared with a recording apparatus 11D in the example of FIG. 6, a CPU 321 of FIG. 6 has performance higher than that of the CPU 221 of FIG. 4, and the functions of the DEMUX unit 234 of FIG. 4 have been transferred to the CPU 321. Therefore, in the recording apparatus 11D in the example of FIG. 6, the tuner unit 233 is directly connected to the bus 224, and the DEMUX unit 234 is omitted as a component.

That is, if a high-performance CPU such as the CPU 321 can be adopted, it is possible to implement many functional blocks among the functional blocks shown in FIG. 1 as software executed by such a CPU.

Therefore, if a CPU having a further higher performance can be adopted, functions of the video/audio compression format converter 235 can also be transferred to such a CPU. As a component of the recording apparatus 11 to which the present invention is applied, a hardware circuit such as the video/audio compression format converter 235 can be omitted.

That is, the series of processes described above can also be carried out by software. In such a case, a program constituting the software is installed from a network or a recording medium into a computer that is incorporated in specialized hardware or, for example, a general-purpose personal computer that can perform various functions by installing various programs therein.

Such a recording medium containing a program will be described with reference to, for example, FIG. 6. The recording medium is formed of a removable medium (packaged medium) 232 composed of a magnetic disk (including a floppy disk), an optical disc (including a CD-ROM (Compact Disc-Read Only Memory), a DVD (Digital Versatile Disc), or a Blue-ray (trademark) disc), a magneto-optical disc (including an MD (Mini-disk)), or a semiconductor memory, in which a program is recorded, the recording medium being distributed to provide the program to the user separately from the main unit of the apparatus. In addition, the recording medium is formed of the ROM 222 and the HDD 230 in which a program is recorded, which are provided to the user by being incorporated in advance into the main unit of the apparatus.

Alternatively, as shown in FIG. 6, such a recording medium contain a program is formed of a ROM (not shown) in the CPU 321, in which a program is recorded, which is provided to the user by being incorporated in advance into the main unit of the apparatus.

In this specification, the steps describing a program recorded on a recording medium include not only processing which is carried out chronologically in the order thereof but also processing which is executed in parallel or individually although it is not necessarily processed chronologically.

It should be understood by those skilled in the art that various modifications, combinations, sub-combinations and alterations may occur depending on design requirements and other factors insofar as they are within the scope of the appended claims or the equivalents thereof.

What is claimed is:

1. A recording apparatus for recording one or more pieces of content provided as stream data on a recording medium, the recording apparatus comprising:
bit-rate setting means for variably setting a bit rate when a processing unit part is recorded on the recording medium in accordance with content in the processing unit part within the one or more pieces of content for each processing unit part for which a recording process is performed on the recording medium within the stream data; and
recording control means for performing control so that the stream data is sequentially recorded on the recording medium for each processing unit part at each bit rate that is variably set for each processing unit part by the bit-rate setting means.

2. The recording apparatus according to claim 1, further comprising:
feature information detection means for detecting feature information indicating a predetermined feature of the processing unit part; and
content recognition means for recognizing the content in the processing unit part on the basis of the feature information detected by the feature information detection means,
wherein the bit-rate setting means variably sets a bit rate for the processing unit part in accordance with the recognized content of the content recognition means.

3. The recording apparatus according to claim 1, wherein the one or more pieces of content constituting the stream data is classified into a first type and a second type whose degree of importance is defined in advance to be lower than that of the first type, and
when the processing unit part corresponds to the first type of content, the bit-rate setting means sets the first bit rate as a bit rate for the processing unit part, and when the processing unit part corresponds to the second type of content, the bit-rate setting means sets the second bit rate lower than the first bit rate as a bit rate for the processing unit part.

4. The recording apparatus according to claim 3, wherein the first type of content is a main part section of the content and the second type of content is a commercial message section of the content.

5. The recording apparatus according to claim 3, wherein the first type of content is a highlight scene of the content, and the second type of content is a general scene.

6. The recording apparatus according to claim 1, wherein the bit-rate setting means performs setting of varying a screen resolution for the processing unit part as a variable setting of a bit rate for the processing unit part.

7. The recording apparatus according to claim 1, wherein the stream data is compression-coded in accordance with a predetermined type of compression format and is recorded on the recording medium, and
the bit-rate setting means performs setting of varying the predetermined type of compression format applied to the processing unit part as a variably setting of a bit rate for the processing unit part.

8. A recording method for use with a recording apparatus for recording one or more pieces of content provided as stream data on a recording medium, the recording method comprising the steps of:
variably setting a bit rate when a processing unit part is recorded on the recording medium in accordance with content in the processing unit part within the one or more pieces of content for each processing unit part for which a recording process is performed on the recording medium within the stream data; and
performing control so that the stream data is sequentially recorded on the recording medium for each processing unit part at each bit rate that is variably set for each processing unit part.

9. A program to be executed by a computer for performing control so that one or more pieces of content provided as stream data are recorded on a recording medium, the program comprising the steps of:
variably setting a bit rate when a processing unit part is recorded on the recording medium in accordance with content in the processing unit part within the one or more pieces of content for each processing unit part for which a recording process is performed on the recording medium within the stream data; and
performing control so that the stream data is sequentially recorded on the recording medium for each processing unit part at each bit rate that is variably set for each processing unit part.

10. A recording apparatus for recording one or more pieces of content provided as stream data on a recording medium, the recording apparatus including:
a bit-rate setting unit configured to variably set a bit rate when a processing unit part is recorded on the recording medium in accordance with content in the processing unit part within the one or more pieces of content for each processing unit part for which a recording process is performed on the recording medium within the stream data; and
a recording controller configured to perform control so that the stream data is sequentially recorded on the recording medium for each processing unit part at each bit rate that is variably set for each processing unit part by the bit-rate setting unit.
